(19) United States
(12) Patent Application Publication
(10) Pub. No.: US 2023/0367641 A1
(43) Pub. Date: Nov. 16, 2023

(54) Centralized Control For Computing Resource Management

(71) Applicant: Google LLC, Mountain View, CA (US)

(72) Inventor: ChianHwa Yang, Issaquah, WA (US)

(21) Appl. No.: 17/745,166

(22) Filed: May 16, 2022

(51) Int. Cl. G06F 9/50; G06F 9/455

(52) U.S. Cl. CPC G06F 9/505; G06F 9/5072; G06F 9/45558; G06F 2209/5011; G06F 2009/4557; G06F 2009/45583

(57) ABSTRACT

A method and system for centralized capacity management using a common supply-demand matching (SDM) logic framework for matching resources of a cloud computing environment with requests for the resources of the cloud computing environment. A global cloud inventory availability system may access the SDM logic framework, match the resources with the requests in accordance with the SDM logic framework based at least in part on lead times associated with the resources and requests, receive capacity planning signals from a plurality of capacity management subsystems assigned to perform different capacity management action types, and for each capacity planning signal, transmit an indication of the matched resources and requests relevant to the capacity planning signal to the capacity management subsystem from which the capacity planning signal was sent.

### BACKGROUND

In cloud computing networks, it is necessary to track and manage computing resource availability and forecast inventory to meet both current and future user demands. Tracking and managing available computing resources can be used to avoid stockouts, which is when a demand for virtual machine (VM) creation is denied due to a lack of available resources in the target VM location.

For example, a capacity management system may admit user demands, such as projects, and rebalance supply, such as available computing resources, according to a predefined set of supply-demand matching (SDM) rules. SDM rules may define various actions according to corresponding scenarios, such as capacity rebalancing between clusters in response to increased user demand, steering demand in response to resource surplus, adjusting configurations at groups of computing resources in response to increased or decreased demand, and so on.

However, as cloud computing networks grow in scale, matching incoming demands with available supply becomes increasingly complex. Often, a cloud computing network may include multiple network subsystems, each including its own separate capacity management system. This creates multiple records of incoming demand and available capacity and no single source of truth for the system as a whole. Additionally, supply movement controls may not be aware of incoming demand or vice versa.

Furthermore, the separate capacity management systems may apply different sets of SDM rules in order to achieve different objectives. For instance, one subsystem tasked with handling imminent demand signals may operate according to one set of SDM rules that considers both current demand and current supply, while another subsystem responsible for rebalancing inventory may operate according to a different set of SDM rules that considers only current supply. This makes synchronization between the subsystems difficult. For example, continuing with the example of two subsystems, each subsystem may address the same scenario with a different action. For example, the subsystem handling demand signals may address current excess supply by diverting incoming demand towards a location of the excess supply, while the subsystem balancing inventory may address the same excess supply by diverting the excess supply towards a location with less available supply.

Furthermore, existing capacity management system tracking availability of virtual machines define machine fungibility according to domain, whereby available inventory exists when machines are available in the domain. However, this definition does not take into account the inability of some VM types to utilize the available machines. Therefore, a stockout error can occur even when there are available machines in the VM's assigned domain if the available machines cannot be utilized by the VM type.

### BRIEF SUMMARY

The present disclosure addresses conflicts in capacity management by centralizing the capacity management in a central system that communicates with other capacity management subsystems. The central system stores one or more common frameworks for matching supply and demand with one another, and communicating such rules and matching results with the subsystems.

In an aspect of the present disclosure, a method includes: receiving, by one or more processors, supply and demand signaling indicating one or more changes in available computing resource inventory in a cloud computing environment; updating, by the one or more processors, a record of available computing resource inventory in response to the supply and demand signaling; receiving, by the one or more processors, a first capacity planning signal from a first capacity management subsystem, and a second capacity planning signal from a second capacity management subsystem, the first capacity management subsystem assigned to perform a first capacity management action type, and the second capacity management subsystem assigned to perform a second capacity management action type different from the first capacity management action type; applying, by the one or more processors, a common supply-demand matching (SDM) logic to each of the first capacity planning signal and the second capacity planning signal; transmitting, by the one or more processors, a first capacity management signal to the first capacity management subsystem, the first capacity management signal indicating to perform a first action of the first capacity management action type based on the common SDM logic; and transmitting, by the one or more processors, a second capacity management signal to the second capacity management subsystem, the second capacity management signal indicating to perform a second action of the second capacity management action type based on the common SDM logic.

In some examples, each of the first capacity management action type and the second capacity management action type may be selected from the group consisting of: reserving computing resource inventory for a forecasted demand; determining pool sizes for domains of the cloud computing environment; moving computing resource inventory between domains of the cloud computing environment; moving projects between domains of the cloud computing environment; and moving demand for computing resource inventory between domains of the cloud computing environment.

In some examples, one or more changes in available computing resource inventory indicated by the supply and demand signaling may include at least one of central processing unit (CPU) capacity, random access memory (RAM) size, or solid state drive (SSD) size, and the SDM logic may match demand to supply based at least in part on the one or more changes in available computing resource inventory indicated by the supply and demand signaling.

In some examples, the common SDM rules may include at least one of: packing a location to reduce fragmentation of stored data; requiring supply signaling to be matched with demand on a first-come-first-served basis; avoiding inventory that is held back from being counted towards currently available capacity; applying a multiplier to a location in which available resources are overcommitted to reduce a likelihood of further resources being committed; applying a cost efficiency weighting to available capacity based on machine type; and avoiding a single virtual machine (VM) from being split across multiple machines.

In some examples, the supply signaling may further indicate a supply lead time for new computing resource inventory to become available in the cloud computing environment, a record of available computing resource inventory may include recording the lead time, and the demand signaling may be associated with a demand lead time indicative of when new demand will be received.

In some examples, the common SDM logic may be configured to match supply signaling to demand signaling based at least in part on the supply lead time and the demand lead time.

In some examples, the common SDM logic may be configured to match imminent demand with currently available computing resources, and to match forecasted demand with future available computing resources.

In some examples, each of the supply lead time and the demand lead time may be selected from a plurality of lead time categories, and the lead time categories may include at least: an imminent lead time indicating immediately available computing resources and immediate computing resource demand, respectively; a reserved lead time indicating incoming computing resources that will be available on the order of days and forecasted computing resource demand that will be received on the order of days, respectively; and an in-transit lead time indicating incoming computing resources that will be available on the order of weeks and forecasted computing resource demand that will be received on the order of weeks, respectively.

In some examples, for supply signaling indicating the in-transit lead time, the supply signaling may further indicate a vendor of the incoming computing resources, and an amount of the incoming computing resources that will be available on the order of weeks may be approximated based at least in part on historical fulfillment data of the vendor.

In some examples, the supply signaling may indicate a VM type, and the common SDM logic may be configured to match supply signaling to demand signaling based at least in part on mappings between VM types and compatible machine types.

Another aspect of the disclosure is directed to a system including: memory storing a supply-demand matching (SDM) logic framework for matching resources of a cloud computing environment with requests for the resources of the cloud computing environment, each of the resources and requests including an indication of lead time; and one or more processors of a global cloud inventory availability system configured to: access the SDM logic framework; match the resources with the requests in accordance with the SDM logic framework based at least in part on the lead time; receive, from a plurality of capacity management subsystems, a plurality of respective capacity planning signals, wherein each capacity management subsystem is assigned to perform a different capacity management action type; and for each capacity planning signal, transmit an indication of the matched resources and requests relevant to the capacity planning signal to the capacity management subsystem from which the capacity planning signal was sent.

In some examples, the plurality of action types may be selected from the group consisting of: reserving computing resource inventory for a forecasted demand; determining pool sizes for domains of the cloud computing environment; moving computing resource inventory between domains of the cloud computing environment; moving projects between domains of the cloud computing environment; and moving demand for computing resource inventory between domains of the cloud computing environment.

In some examples, the one or more processors may be configured to match the resources with the requests based further on at least one of computation capacity, storage capacity or virtual machine (VM) type.

In some examples, the SDM logic framework may include at least one of: a bin packing rule for reducing fragmentation of stored data; a VM integrity rule for ensuring that VMs are not scheduled across multiple machines of the resources of the cloud computing environment; a place in line rule for addressing requests on a first-come first-served basis; a holdback rule for ensuring that held-back resources are not counted towards available capacity of the cloud computing environment; or a clustering rule for moving requests between cells of a common cluster of the cloud computing environment.

In some examples, the SDM logic framework may include at least three of the bin packing rule, the VM integrity rule, the place in rule, the holdback rule, and the clustering rule.

In some examples, lead time for the resources may indicate a time that the resources become available in the cloud computing environment, and lead time for the requests may indicate when projects included in the requests will be executed.

In some examples, the one or more processors may be configured to: match resources having an imminent lead time with requests having the imminent lead time; match resources having a ready-for-reservation lead time with requests having the ready-for-reservation lead time; transmit an indication of the matched resources and requests having the imminent and ready-for-reservation lead times to one or more capacity management subsystems configured to perform one of short-term supply shaping or short-term demand steering.

In some examples, the one or more processors may be configured to: match resources having an in-transit lead time with requests having the in-transit lead time; and transmit an indication of said matched resources and requests having the in-transit lead time to one or more capacity management subsystems configured to perform one of long-term supply shaping or long-term demand forecasting.

In some examples, the one or more processors may be configured to determine a level of confidence of delivery of the resources having the in-transit lead time based on a vendor delivering the resources having the in-transit lead time, and historical fulfillment data of the vendor.

In some examples, the memory may include a mapping between a plurality of VM types and a plurality of machine platforms, and the one or more processors may be configured to match the resources with the requests in accordance with the SDM logic framework based further on the mapping.

### BRIEF DESCRIPTION OF THE DRAWINGS

FIG. 1 is a block diagram of an example system in accordance with an aspect of the present disclosure.

FIG. 2 is a block diagram of an example computing systems included in the example of FIG. 1.

FIG. 3 is a block diagram of an example data flow through subsystems of an example system in accordance with an aspect of the present disclosure.

FIG. 4 is a flow diagram of an example centralized capacity management routine according to an aspect of the present disclosure.

### DETAILED DESCRIPTION

### Overview

The present disclosure provides a global cloud inventory availability (GCIA) system to function as an authoritative source of supply and demand information. The GCIA system may communicate with the subsystems of the capacity management system in order to ensure that the subsystems are operating on the same supply and demand information. Additionally, the GCIA system includes an SDM engine that applies a comprehensive set of rules for managing existing and future inventory, so that conflicting actions between subsystems are avoided. A subsystem may communicate an SDM request to the GCIA system, and the GCIA system may return an SDM decision to the requesting subsystem. Since SDM decisions returned to each of the subsystems are determined according to the same SDM logic, the actions taken by each of the subsystems may be consistent with one another.

In order to support supply and demand signaling from each of the subsystems of the capacity management system, the SDM logic of the GCIA system may be configured to support both currently available and forecasted streams of supply and demand. This may be accomplished by the GCIA system through classification of both supply and demand signaling according to lead time. In other words, the GCIA system can differentiate between inventory that is imminently available and inventory that will take longer to become available, and can differentiate between imminent demand and forecasted demand. This allows the GCIA system to match supply signaling together with demand signaling based on the supply and demand having matching lead times. In other words, the GCIA may earmark immediately available inventory to meet an immediate demand for computing resources, and may earmark inventory that will be available at a future time to meet a forecasted spike in demand at the future time. Incorporating lead time into SDM rules can improve the efficiency of the SDM, since currently available supply need not be reserved for future demand and instead can be allocated to imminent demand.

The GCIA system also operates by classifying incoming inventory according to machine type instead of machine domain. This allows the SDM rules to match the VM type of the demand signaling to the machine type or platform type of the available inventory. By mapping VM type to machine type, it is ensured that the GCIA system will earmark machines that are capable of being utilized by the matched VM type. This avoids a potential stockout scenario due to mismatch between VM type and machine type.

Overall, the GCIA system provides a single, authoritative source for capacity planning subsystems to query inventory availability. This allows inventory availability to be updated in a streamlined fashion, meaning that each subsystem is relying on the most up to date availability information, as well as the same availability information as the other capacity planning subsystems. The GCIA system also provides for more efficient allocation of inventory since allocations are based in part on lead time for both inventory and for demand. The GCIA system also provides a more fine-grained definition of inventory fungibility, so that demand is properly matched with compatible inventory.

### Example Systems

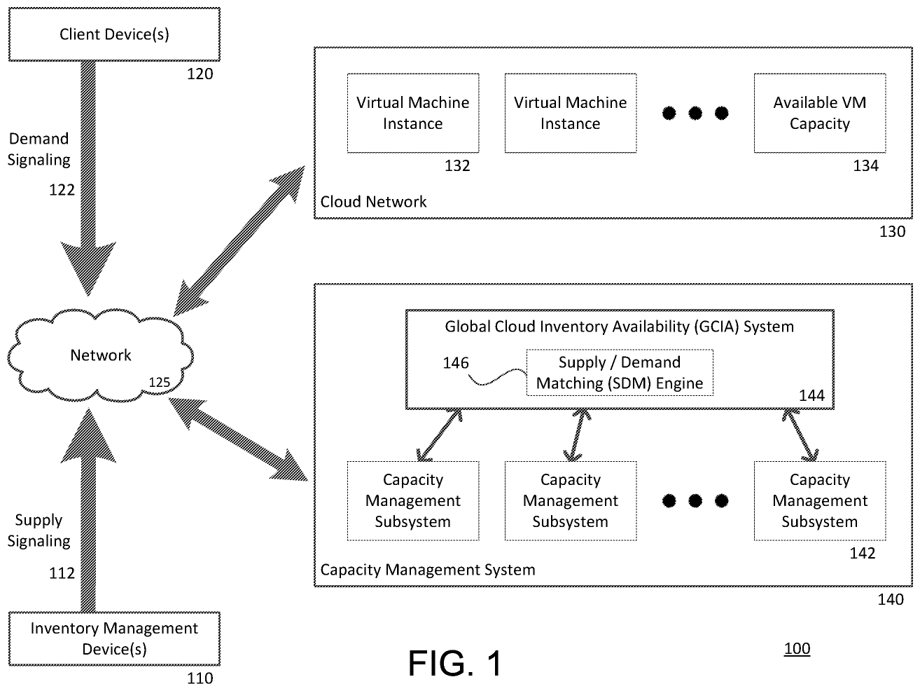

FIG. 1 illustrates an example system 100 including one or more inventory management devices 110 providing supply signaling 112, and one or more client devices 120 providing demand signaling, over a network connection 125. The system 100 further includes one or more cloud-based devices 130 for computing, for storage or both. The system 100 further includes a capacity management system 140 communicatively connected to each of the inventory management devices 110, the client devices 120, and the cloud computing environment 130 through the network 125. The capacity management system 140 may receive the supply signaling 112 and the demand signaling 122 and configure the cloud computing environment 130 according to the supply signaling 112 and the demand signaling 122. Configuring the cloud computing environment 130 may involve virtually clustering certain devices 130 together, assigning or reassigning devices between the virtual clusters, assigning or reassigning tasks and datasets between the devices 130.

The cloud computing environment 130 may include an assortment of physical machines, such as servers, processors, storage arrays, and so on. Computing capacity, storage capacity, or both, of the physical machines may be used to create virtual machine (VM) instances 132. The VM instances 132 may be used to store and process data according to instructions in the demand signaling 122. Unused capacity of the physical machines is shown in FIG. 1 as available capacity 134, and may be used to create additional VM instances, or to increase capacity of existing VM instances 132.

Physical devices may be added or taken away from the cloud computing environment 130 at any given time. Examples of physical devices being subtracted from the available capacity 134 could include servers being taken offline for maintenance, storage arrays becoming corrupted, and so on. Examples of physical devices being added to the available capacity 134 may include any computing device hardware being installed and integrated into the system 100 in order to scale up an overall capacity of the system 100. The capacity management system 140 may be notified of added or removed physical devices through the supply signaling 112 received from the one or more inventory management devices 110. For instance, the inventory management devices 110 may include entries about purchase orders of new machines for the cloud computing environment 130, maintenance operations on existing machines of the cloud computing environment 130, and the like.

The capacity management system 140 may include a plurality of capacity management subsystems 142 for managing configuration of the cloud computing environment 130. Configuring the cloud computing environment 130 may involve supply steering, such as moving around available cloud computing inventory between virtually assigned cells or clusters in order to meet changes in demand for the cloud computing inventory. Additionally or alternatively, configuring the cloud computing environment 130 may involve demand steering, such as moving around projects or datasets between the VM instances 132, such as towards clusters and zones where there is available capacity 134.

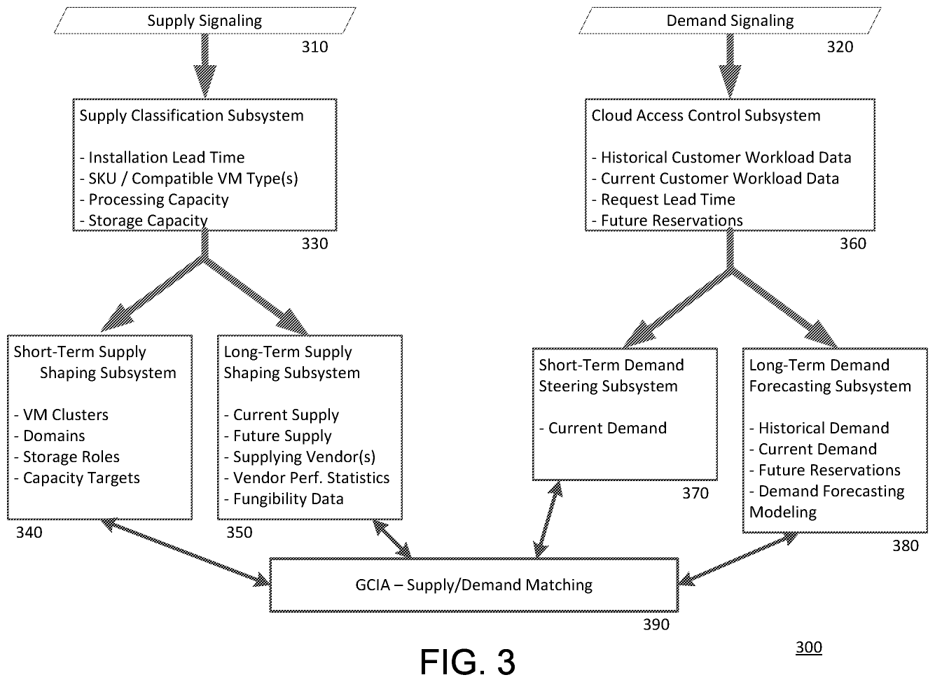

Each capacity management subsystem 142 may be arranged to handle a different aspect of configuring the cloud computing environment 130. As such, each subsystem may receive a different set of inputs and may provide a different set of outputs depending on its respective role in the capacity management system 140. For instance, one subsystem 142 may be tasked with supply steering, and may receive a stream of supply signaling in order to balance VM capacity within the system 100 based on the supply steering. For further instance, another subsystem 142 may be tasked with demand steering, and may receive a stream of demand signaling in order to evenly distribute the demand across the VM capacity of the system 100. Supply steering and demand steering may be advantageous for running the system, so that failures such as stockouts can be avoided. Examples of capacity management subsystems 142 are described in greater detail herein in connection with FIG. 3.

The capacity management system 140 further includes a global cloud inventory availability (GCIA) system 144. The GCIA system 144 is communicatively connected to each of the capacity management subsystems 142. The GCIA system 144 may assist each of the capacity management subsystems 142 in determining how to manage the cloud computing environment 130, including both supply management and demand management. The GCIA system 144 includes a supply/demand matching (SDM) engine 146 for receiving inputs from each of the capacity management subsystems 142 and processing the inputs according to a common set of SDM rules. The SDM rules may set uniform parameters and guidelines to which each of the capacity management subsystems 142 must abide, in order that two capacity management subsystems 142 do not take conflicting actions based on the same or similar set of inputs. Communication between the GCIA system 144 and the capacity management subsystems 142, whereby after the SDM matching engine 146 processes a set of inputs from a capacity management subsystem 142, a set of instructions may be outputted to the capacity management subsystem 142 in order to instruct the capacity management subsystem 142 to take action in accordance with the SDM rules.

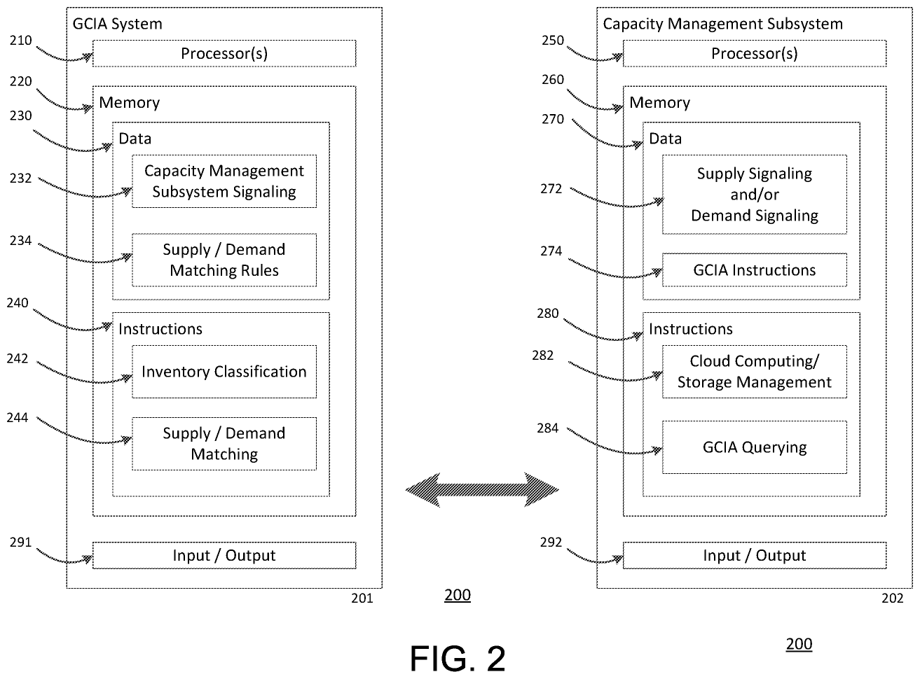

FIG. 2 is a block diagram illustrating features of an example capacity management system 200, such as the capacity management system 140 of FIG. 1. As with the example capacity management system 140 of FIG. 1, the capacity management system 200 of FIG. 2 includes both a GCIA system 201 and multiple capacity management subsystems. For the sake of clarity, only a single capacity management subsystem 202 is shown in FIG. 2, although it should be understood that any number of capacity management subsystems may be included in the capacity management system 200.

The GCIA system 201 may include one or more processors 210 and memory 220. Also, the capacity management subsystem 202 may include one or more processors 250 and memory 260. Although the processors and memory are shown as being entirely separate from one another, in some examples, the two blocks may share some or all processors, some or all memory, or any combination thereof.

The processors 210, 250 can be a well-known processor or other lesser-known types of processors. Alternatively, the processors 210, 250 can be a dedicated controller such as an application-specific integrated circuit (ASIC).

The memory 220, 260 can store information accessible by the processor 210, 250, including data 230, 270 that can be retrieved, manipulated or stored by the processor, instructions 240, 280 that can be executed by the processor 210, 250, or a combination thereof. The memory 220, 260 may be a type of non-transitory computer readable medium capable of storing information accessible by the processor 210, 250 such as a hard-drive, solid state drive, tape drive, optical storage, memory card, ROM, RAM, DVD, CD-ROM, write-capable, and read-only memories.

Although FIG. 2 functionally illustrates the processors 210, 250 and corresponding memories 220, 260 of each component 201, 202 as being included within a single block, the processor and memory may actually include multiple processors and memories that may or may not be stored within the same physical housing. For example, some of the data and instructions can be stored on a removable CD-ROM, persistent hard disk, solid state drive (SSD), and others. Some or all of the instructions and data can be stored in a location physically remote from, yet still accessible by, the processor. Similarly, the processor can actually include a collection of processors, which may or may not operate in parallel.

Each of the GCIA system 201 and capacity management subsystem 202 may further include input/output components 291, 292 for receiving and transmitting data with other components of the system. Received data may include streams of supply signaling and demand signaling. Transmitted data may include instructions to the computing and storage devices of the cloud computing environment. The input/output components 291, 292 of the GCIA system 201 and capacity management subsystem 202 may also communicate with one another.

In the GCIA system 201, the data 230 stored in the memory 220 may include capacity management subsystem signaling 232 received from the capacity management subsystem 202. This signaling 232 may be stored at the GCIA system for processing according to the SDM rules 234, which may also be stored in the memory 220 of the GCIA system 201. The instructions 240 of the GCIA system 201 may include one or more routines for processing the capacity management subsystem signaling 232, including but not limited to an inventory classification routine 242 for classifying inventory identified in supply signaling, and a supply/demand matching routine 242 for applying the SDM rules 234 to the capacity management subsystem signaling 232 and to derive a set of instructions for managing the existing VMs and available VM capacity of the computing and storage devices in accordance with the SDM rules.

In the capacity management subsystem 202, the data 270 stored in the memory 260 may include one or both of supply signaling and demand signaling 272 received from supply and demand sources, such as the inventory management devices 110 or client devices 120. The supply signaling and demand signaling 272 may be stored at the capacity management subsystem 202 for processing according to instructions received from the GCIA 201 in accordance with the SDM rules 234, which may also be stored in the memory 270 of the capacity management subsystem 202. The instructions 280 of the capacity management subsystem 202 may include one or more routines for processing the supply signaling and demand signaling 272, including but not limited to a cloud computing management routine 282 for controlling supply steering and demand steering within the cloud computing environment, and a GCIA querying routine 284 for querying the GCIA system 201 for instructions to guide performance of the cloud computing management routine 282.

FIG. 3 is a block diagram illustrating a flow of information within an example system 300 of the present disclosure, such as system 100 of FIG. 1.

The example system 300 of FIG. 3 receives both supply signaling 310 and demand signaling 320 from various signal sources. The system 300 may include several different subsystems 330-380 responsible for receiving different elements of the supply signaling 310 or demand signaling 320 and processing the received elements according to each subsystem's respective role within the system at large. Some subsystems may receive and process supply signaling 310 and make decisions about the cloud computing environment inventory based on the supply signaling 310. Some subsystems may receive and process demand signaling 320 and make decisions about the distributions of operations performed in the cloud computing environment based on the demand signaling 320. Although not shown in FIG. 3, one or more subsystems may receive and process a combination of supply signaling 310 and demand signaling 320. Additionally, as shown in FIG. 3, each of the subsystems 330-380 is communicatively connected, directly or indirectly, to the GCIA system 390. The GCIA system 390 is responsible for implementing a common set of SDM rules for each of the subsystems so that supply signaling 310 and demand signaling 320 is managed consistently and coherently throughout the system 300.

The supply signaling 310 may include communications indicating the immediate or eventual availability or unavailability of cloud computing environment inventory. For instance, the supply signaling could indicate a new order of machines for the cloud computing environment. The signaling indicating the new order may further indicate any one or combination of delivery details, such as an inventory stock keeping unit (SKU) of the ordered machines, unique identifiers for each of the machines, a vendor providing the machines, a projected time of delivery of the machines, and a projected time of integration or installation of the machines into the cloud computing environment. The signaling indicating the new order may further indicate specifications or details about the machines' capabilities, such as any one or combination of a number of central processing units (CPUs) or other indication of an amount of computing capacity included in the machines, an amount of random access memory (RAM), hard disk space, solid state drive (SSD) space, or other indication of an amount of storage capacity included in the machines, and a machine platform type which may indicate what types of VMs are compatible with the machines. Example types of VMs may include N1, E2, N2 and so on.

In some examples, the signaling indicating the new order may use a soft SKU to improve capacity management efficiency. The soft SKU may represent shared resource pools, whereby each soft SKU may pool together a limited number of standard SKUs. Soft SKUs may be used to set fungibility rules for the machines, whereby if a machine with a requested type is not available, another type of machine with the same soft SKU as the machine with the requested type may be offered instead.

Another example of supply signaling 310 may be a signal indicating maintenance work on one or more machines of the cloud computing environment, whereby the one or more machines may be taken offline for maintenance. Another example of supply signaling 310 may be a signal indicating an error at one or more machines of the cloud computing environment, whereby the one or more machines may be fully or partially unusable for satisfying customer demand due to the errors. Maintenance work signaling and machine error signaling may also indicate the identifications and properties of the machines taken offline. and a projected time when the machines will be back up and running. In the case of maintenance, the signaling may also include a projected start time for the maintenance.

The demand signaling 320 may include requests from users of the cloud computing environment for access to storage resources, computing resources or both. The requests may be either for immediate access to the available resources, or a reservation for future access to the resources. The request may indicate a projected time for which the access is requested, which may include a start time for the access and optionally and end time or information from which an end time may be predicted, such as a size of a project requested to be performed using computing resources of the cloud computing environment. The requests may further indicate information about the requestor such as an identity of the requestor, a time of the request, a type of machine that the requestor is requesting access to, an amount of computing resources, storage resources or both that are being requested, an urgency of the request, and so on.

First, with attention to the supply signaling, 310, in the example of FIG. 3, the supply signaling 310 is initially received by a supply classification subsystem 330. The supply classification subsystem 330 is responsible for interpreting the supply signaling 310 to determine one or more properties of the supply signaling. The determined properties may include any of the properties of the supply signaling described herein, such as SKU, VM types that are compatible with the inventory, a processing capacity of the inventory, a storage capacity of the inventory, and so on.

In some examples, the supply classification subsystem 330 may include a mapping of VM types to platform types. For requests of computing resources requiring a specific type of VM, the mapping between VM types and platform types can be used to identify which machines can be used to fulfill received requests, as well as which machines can be used to replace one another in the event of changes to the supply/demand matching.

Additionally, for new inventory added to the cloud computing environment, the supply classification subsystem 330 may assign one or more new properties to the new inventory. One example new property is a supply installation lead time classification for the new inventory. The supply installation lead time may classify when the new inventory will become available in the cloud computing environment. For instance, the inventory may be classified using either a first category indicating imminent lead time and a second category indicating reserved lead time. The imminent lead time may indicate that the associated inventory is already deployed in a datacenter or other station of the cloud computing environment and is ready to serve guest VMs to satisfy imminent demand at the cloud computing environment. By comparison, the delayed lead time may indicate that the associated inventory is forecasted to be available at a future time and may be used to satisfy reservations for inventory at the cloud computing environment or earmarked for forecasted demand spikes.

Within the classification of delayed lead time, a more granular classification may be applied to distinguish between inventory that will be available on the order of days and inventory that will only be available on the order of weeks. For instance, a new order of machines that has been delivered but not yet installed may be forecasted to be available on the order of days and may be used to satisfy a computing resource reservation scheduled in a few days' time, whereas a new order of machines that has not yet shipped may not be expected to arrive and be installed for a matter of weeks, meaning that it is not suitable for satisfying the same computing resource reservation. Inventory that has already been received and is ready to be reserved is referred to herein as having a “reserved lead time” classification, and inventory that is still in transit is referred to herein as having an “in-transit” classification.

Another example of a new property that may be attributed to the inventory is a confidence level of availability, indicating a level of confidence that the inventory is available or will be available by a forecasted time. In the case of inventory with imminent lead time, the confidence may be high, such as 100% or close to 100% in the case of a numerical value attributed to the level of confidence. In the case of inventory with delayed lead time, the level of confidence may vary depending on multiple factors, such as whether the inventory has been received from the vendor, and past performance history of the vendor, and telemetry concerning the current shipment. For instance, if the inventory is classified under the reserved lead time, then the level of confidence may be high, such as 100% or close to 100%. However, if the inventory classified as in transit, the confidence level may be lower than 100%. The confidence level may further be based on a past track record of the vendor in previously supplying inventory, whereby the better the vendor's track record, the higher the confidence level may be. Track record history may include not only the time the vendor takes to deliver the inventory, but also whether the delivered inventory has historically worked as expected. For instance, if a vendor has a history of delivering 80% working products while the remaining 20% immediately requires maintenance or must be returned, then the confidence level can be adjusted to reflect this. Ultimately, the confidence level can be used as a weighting factor to increase or diminish the system's reliance on inventory that has not yet been received so as not to overpromise and underdeliver resources to customers.

The supply classification subsystem 330 may further determine to which other subsystem or subsystems to forward the supply signaling 310. For instance, in the example of FIG. 3, the system 300 includes two supply shaping subsystems, a short-term supply shaping subsystem 340 and a long term supply shaping subsystem. Supply signaling for inventory with imminent lead time may be provided to at least the short-term supply shaping subsystem 340, whereas supply signaling for inventory with in-transmit lead time may be provided to at least the long-term supply shaping subsystem 350. The supply signaling for inventory with reserved lead time may be provided to either one or both of the two supply shaping subsystems. For instance, in one example system, the short-term supply shaping subsystem 340 may be tasked with scheduling any inventory with a confidence level of or close to 100%, meaning that the signaling for inventory with reserved lead time is provided. Alternatively, if the short-term supply shaping subsystem 340 is responsible only for balancing currently available supply, then the signaling for inventory with reserved lead time may not be provided. For further instance, the long-term supply shaping subsystem 350 may take all supply signaling 310 in order to build a forecast for future supply needs based on current supply availability.

In one example implementation, the short-term supply shaping subsystem 340 may be a service that automates the configuration of the cloud computing environment's fleet of computing resources on which the VMs are run. The service may ingest signaling for imminent and reserved lead time inventory, and may assign the inventory to meet an intended state of the cloud computing environment for providing necessary resources to all customers of the cloud computing environment while avoiding stockouts. The service may be cluster-scoped, meaning that supply resources may be clustered in a manner that achieves the intended state. The service may assign machines to domains and storage roles as the machines enter the cloud computing environment. Machines may then be reassigned between domains based on capacity targets for each domain. As such, the service may track each of the VM clusters, the assigned domains, the assigned storage roles of the previously entered machines, and the capacity targets for each domain.

The short-term supply shaping subsystem 340 may also be responsible for setting machine holdback thresholds indicating a maximum amount of capacity that a cluster of machines may hold before no further requests are assigned to the machines. The threshold may act as a buffer to provide some excess capacity to manage projects that already exist at the machines while reducing the likelihood of a stockout scenario. The threshold may be adjusted as the stockout scenario likelihood increases or decreases, whereby the more likely a stockout becomes, the larger the buffer that is reserved at the machines.

The long-term supply shaping subsystem 350 may be a service that forecasts capacity on a long-term scale in order to manage inventory that is in-transit. The service may project an amount of added capacity for different clusters or domains of the cloud computing environment based on such factors as a current available supply, future available supply, information about the vendor or vendors transporting the inventory, including vendor performance data, and fungibility data indicating the interchangeability of one machine type for another machine type in case one portion of machines is operational in the future while a different portion of the machines is not operational. This may be adjusted or updated automatically according to a feedback loop so that any delays that appear in the transit process can be integrated into previous forecasts and used to update delivery timelines, confidence levels and other availability expectations. The long-term supply shaping subsystem 350 service can also be capable of projecting domains for the incoming machines, as well as reassigning the machines between domains based on changes in shipment schedules and vendor performance. The long-term forecasting is advantageous to avoid situations in which inventory is expected to be increased but falls short of expectations due to failures in transit and delivery of the machines.

Next, with attention to the demand signaling 320, in the example of FIG. 3, the demand signaling 320 is initially received by a cloud access control subsystem 360. The cloud access control subsystem 360 is responsible for interfacing client devices with the other capacity management subsystems in order to direct resource requests to their appropriate destinations. Information received at the cloud access control subsystem 360 may be interpreted to determine a customer sending the request, and to store the request with current and historical workload data of the customer. The cloud access control subsystem 360 may also be responsible for scheduling user reservations of computing resources, thereby effectively assuring users that the cloud computing environment has the capacity to meet the user's future computing needs. Conversely, if the cloud access control subsystem 360 determines that the user's request cannot be met, the subsystem is capable of communicating to the user that the requested capacity is not available.

In some instances, the cloud access control subsystem 360 may also have the ability to differentiate between imminent demand and future demand, whereby imminent demand requires immediately available resources to meet the demand, and future demand can rely on resources that will be available in the future, such as inventory with reserved lead time. Demand signaling 320 can be directed to one or more additional subsystems based on the type of demand contained in the signaling.

In the example of FIG. 3, a short-term demand steering subsystem 370 is provided for directing users' resource requests towards available computing resources of the cloud computing environment. The short-term demand steering subsystem 370 may be capable of directing the requests towards the available resources based on current demand at the system, so that a stream of requests from one or more users is appropriately distributed among the available resources. Directing requests may involve assigning new requests, rebalancing a distribution of existing requests, or a combination thereof. The short-term demand steering subsystem 370 may also be capable of determining whether there are insufficient resources in a system to meet a current demand request, and notify a user of such through the cloud access control subsystem 360 in such a case.

Also in the example of FIG. 3, a long-term demand forecasting subsystem 380 is provided to forecast future demand for computing resources in the cloud computing environment. The long-term demand forecasting subsystem 380 may receive information regards demand signaling from a past amount of time, such as two weeks, a month, two months, four months, six months and so on, to forecast future demand of the system. Typically, receiving more historical demand information can improve forecasts of future demand. The long-term demand forecasting subsystem 380 may be capable of determining whether reservations for computing resources can be fulfilled at a future time and provide capacity assurance to customers when the requests are forecasted to be aligned with future available capacity. Additionally, the long-term demand forecasting subsystem 380 may be capable of recommending aggregate pool sizes for the machines in the cloud computing environment based on forecasted demand, moving projects between clusters within a region of the cloud computing environment in order to balance the remaining free capacity, or both.

The GCIA system 390 is connected to each of the subsystems 330-380 in order to unify supply shaping decisions with demand steering decisions. In operation, an SDM engine of the GCIA system may be invoked by the subsystems 330-380 by way of a remote procedure call (RPC) or library. The GCIA system may return a selection of appropriate supply that matches a given demand, based on factors such as lead time for the supply and the demand.

The GCIA system 390 relies on a predetermined set of SDM rules to ensure that computing resources are handled consistently between the various subsystems. Some of the SDM rules stored at the GCIA system may include the following:
(1) Bin Packing: Packing cells of the cloud computing environment to reduce cell fragmentation.
(2) VM Integrity: Ensuring that a single VM is not scheduled across multiple machines of the cloud computing environment.
(3) Place in Line: Addressing customer requests for computing resources on a first-come first-served basis.
(4) Holdback: Recognizing resources that are on-hold and ensuring that the on-hold resources are not counted towards salable capacity for purposes of forecasting available capacity.
(5) Clustering: Permitting scheduling of VM requests to be moved from one cell to another cell within the same cluster of VMs without incurring performance degradation. In some examples, the VM requests may be moved between zones of the cloud computing environment.
(6) Cost Efficiency: Tracking cost efficiency of different machine types. This may be used to select a machine type for a computing resource request based on the cost efficiency, such as more cost efficient machine types being preferred over other machine types when both are available.
(7) Overcommit Multiplier: Applying weighted costs to overcommitted cells or clusters in order to ensure that further demand is steered away from the overcommitted areas and towards underutilized resources, and to improve forecasts of future resource availability.

These and other rules may ensure that the subsystems 330-380 of the system 300 handle the supply signaling 310 and demand signaling 320 consistently and do not take contradictory action, such as one subsystem responding to a lack of available resources by moving more resources towards that location while another subsystem steers demand away from that same location.

The above example system 300 describes the GCIA system 390 as having a single unified set of SDM rules for all subsystems. However, in some cases, it may not be necessary to unify every subsystem. For example, a first subset of the subsystems may collectively have a first set of SDM rules and a second subset of the subsystems may collectively have a second set of similar SDM rules, but the first set of SDM rules may be irrelevant to the second subset of subsystems and the second set of SDM rules may be irrelevant to the first subset of subsystems. In such a case, the GCIA system may host two independent sets of common SDM rules: one for the first subset of subsystems and one for the second set of subsystems. In other instances, the SDM rules may be divided between subsystem-specific rules that may be applied to one or more subsystems, and global SDM rules that apply to all subsystems.

In the example of FIG. 3, the GCIA system 390 is shown as only interfacing with subsystems and providing guidelines or instructions for the subsystems to perform actions consistent with the SDM rules. However, in other instances, the GCIA system 390 may be responsible for additional tasks within the system 300. For instance, the GCIA system 390 may be further responsible for ingesting signaling for new inventory and classifying the inventory, as described in connection with the supply classification subsystem 330. In such an example, the GCIA system 390 may further use its determined supply classifications to match new inventory that is available or will be available soon to incoming demand, such as by matching supply signaling 310 to demand signaling 320 based at least in part on the supply lead time and the demand lead time. This may involve the GCIA system 390 matching imminent demand with currently available computing resources, and reserved demand with reserved inventory. For further example, the GCIA system 390 may assign imminent supply to incoming demand when possible, and may select reserved supply to satisfy incoming demand when there is no imminent supply available.

### Example Methods

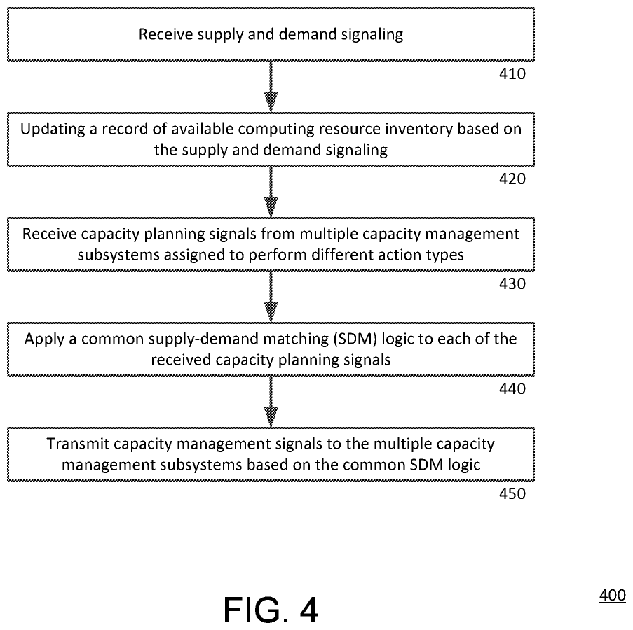

The routines executed by the capacity management subsystems as well as the GCIA system are described in greater detail in connection with FIG. 4. It should be understood that the routines described herein are merely examples, and in other examples, certain steps may be added, subtracted, replaced or reordered.

FIG. 4 is a flow diagram illustrating an example routine 400 for capacity management. Certain steps of the routine are described as being performed by the one or more processors of the GCIA system. However, in other example routines, the processors responsible for at least some of these steps may be switched from the GCIA system to the capacity management subsystems.

At block 410, the GCIA system receives supply and demand signaling. The supply signaling may indicate new inventory being received at a cloud computing environment. The new inventory may include new machines that can be configured as virtual machines for processing customer projects or other requests, or for storage of data, such as datasets on which the projects and other requests are executed. The demand signaling may include the customer projects and requests. Both supply signaling and demand signaling may be associated with respective lead times, indicating an amount of time until the supply becomes available or an amount of time until the customer request needs to be executed, respectively.

At block 420, the GCIA system updates a record of available computing resource inventory based on the supply and demand signaling. The record may be maintained at the GCIA system, and may indicate information about the incoming supply and demand such as the respective lead times. The GCIA system may further classify the incoming supply and demand according to prestored classifications, such as depending on the amount of the lead time, a confidence level of incoming supply to be received, and so on.

At block 430, the GCIA system receives capacity planning signals from multiple capacity management subsystems assigned to perform different action types. The different action types may generally relate to short-term supply shaping, long-term supply shaping, short-term demand steering, long-term demand forecasting, and the like. For example, any of the services described in connection with the subsystems of the system 300 of FIG. 3 may be considered an action type. Action types may include, for sake of example, any one or more of: reserving computing resource inventory for a forecasted demand; determining pool sizes for domains of the cloud computing environment; moving computing resource inventory between domains of the cloud computing environment; moving projects between domains of the cloud computing environment; and moving demand for computing resource inventory between domains of the cloud computing environment.

At block 440, the GCIA system applies a common SDM logic to each of the received capacity planning signals. The common SDM logic may include rules that direct matching of supply, such as available cloud computing environment resources, to demand, such as incoming computing requests from customers. The common SDM logic may be applied uniformly to all subsystems to ensure consistent treatment of the available supply and incoming demand, and to avoid the subsystems taking conflict actions.

At block 450, the GCIA system transmits capacity management signals back to the multiple capacity management subsystems based on the common SDM logic. The capacity management signals may instruct the subsystems as to how to carry out the respective action types of the respective subsystems. As noted in connection with block 440, the capacity management signals may be derived from the uniform application of the SDM logic across the various subsystems so that the subsystems take consistent and coherent actions.

In one example implementation of the routine 400, the GCIA system may operate as a transactional system. In effect, the supply and demand signaling received at block 410 may be received directly or indirectly from the supply and demand sources outside of the system, and may include indications of a type of resource being added or requested, an amount of the resource being added or requested, and a lead time until the resource is added or demanded. Based on the information received at block 410, the GCIA system at block 420 may attempt to match the incoming supply with the incoming demand such that each resource is committed to a corresponding request. Commitment of resources may involve earmarking the resources in the GCIA records so that it is understood by the system at large that resources have been committed.

Resources and requests may be matched to one another based on any one or combination of type, amount available, and lead time, as well as other factors and properties described herein. In the present example implementation, the capacity planning signals received at block 430 may effectively be requests from the various subsystems of the capacity management system to access the updated records of the GCIA system from block 420 so that the subsystems can be informed as to what resources are available and which resources have been earmarked. In this regard, the application of common SDM rules to each of the subsystems at block 440 may be implemented through the providing of a common record of the computing resource commitments to each of the subsystems, so that the information used by each subsystem to shape supply, steer demand, forecast future capacity or requests, and so on, is based on a single source of truth instead of conflicting views of the cloud computing system from the various capacity management subsystems. Thus, the capacity management signals transmitted to the subsystems at block 450 may include, at least in part, the information about computing resource commitments contained in the GCIA system records.

In order for the GCIA system records to remain up to date and relevant, the records may be updated or refreshed on a regular basis, such as on a loop. For example, new machines entered into the GCIA system records may initially marked as imminently available, but at a later time, the machines may be taken down for maintenance. The update loop may process new supply signaling indicating the maintenance event and update the records to indicate that the resources are unavailable based on the new supply signaling. For further example, new machines entered into the GCIA system may initially be marked as reserved and earmarked to satisfy a user request for computing resources having a lead time of two days. However, at a later time, another user request may be received and it may be determined that the earmarked machine is better suited to handle the more recent user request. This may occur, for example, if the earlier request is more flexible about what machine type can be used to fulfill the request but the more recent request requires a specific machine type that only the earmarked machine can fulfill, or if an influx of new resource requests are received at the GCIA system determines to bundle the new requests at a common cluster of machines while steering other requests at the cluster to different locations to rebalance demand within the cloud computing system. In such cases, the update loop may process the new supply signaling indicating the new user request or requests and redirect the original requests to a new machine, thereby negating the original earmarking and possible replacing it with a new earmarking. The update may also involve recalculating a confidence level that the newly earmarked machines will be available for the user. Such information can be conveyed to the user proactively so that the user's expectations can be set appropriately.

The use of a centralized inventory availability system, as described in the capacity management systems and management methods of the present disclosure, has several advantages over capacity management systems lacking centralized control. The centralized system is capable of unifying and applying consistent supply demand matching rules that improve the accuracy of truly available inventory. This has the positive effect of minimizing stranding and stockout scenarios caused by asynchronous systems shaping supply and demand simultaneously. The centralized system is also capable of maintaining up-to-date availability information for incoming supply, and both rapidly and regularly updating customers about guarantees or promises of available inventory as supply chain difficulties occur and are resolved. The centralized system also enables a unified set of fungibility rules to be applied to different machine types, so that the various subsystems connected thereto can efficiently substitute working and available inventory for not working and unavailable machines. Furthermore, the use of a centralized system provides for a more robust and clearer picture of both current and historical inventory availability, thereby improving the system's ability to forecast future availability and set accurate predictions and customer expectations.

Although the technology herein has been described with reference to particular embodiments, it is to be understood that these embodiments are merely illustrative of the principles and applications of the present technology. It is therefore to be understood that numerous modifications may be made to the illustrative embodiments and that other arrangements may be devised without departing from the spirit and scope of the present technology as defined by the appended claims.

Most of the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. As an example, the preceding operations do not have to be performed in the precise order described above. Rather, various steps can be handled in a different order, such as reversed, or simultaneously. Steps can also be omitted unless otherwise stated. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method comprising:
receiving, by one or more processors, supply and demand signaling indicating one or more changes in available computing resource inventory in a cloud computing environment;
updating, by the one or more processors, a record of available computing resource inventory in response to the supply and demand signaling;
receiving, by the one or more processors, a first capacity planning signal from a first capacity management subsystem, and a second capacity planning signal from a second capacity management subsystem, the first capacity management subsystem assigned to perform a first capacity management action type, and the second capacity management subsystem assigned to perform a second capacity management action type different from the first capacity management action type;
applying, by the one or more processors, a common supply-demand matching (SDM) logic to each of the first capacity planning signal and the second capacity planning signal;
transmitting, by the one or more processors, a first capacity management signal to the first capacity management subsystem, the first capacity management signal indicating to perform a first action of the first capacity management action type based on the common SDM logic; and
transmitting, by the one or more processors, a second capacity management signal to the second capacity management subsystem, the second capacity management signal indicating to perform a second action of the second capacity management action type based on the common SDM logic.

2. The method of claim 1, wherein each of the first capacity management action type and the second capacity management action type is selected from the group consisting of: reserving computing resource inventory for a forecasted demand; determining pool sizes for domains of the cloud computing environment; moving computing resource inventory between domains of the cloud computing environment; moving projects between domains of the cloud computing environment; and moving demand for computing resource inventory between domains of the cloud computing environment.

3. The method of claim 1, wherein one or more changes in available computing resource inventory indicated by the supply and demand signaling includes at least one of central processing unit (CPU) capacity, random access memory (RAM) size, or solid state drive (SSD) size, and wherein the SDM logic matches demand to supply based at least in part on the one or more changes in available computing resource inventory indicated by the supply and demand signaling.

4. The method of claim 1, wherein the common SDM rules include at least one of:
packing a location to reduce fragmentation of stored data;
requiring supply signaling to be matched with demand on a first-come-first-served basis;
avoiding inventory that is held back from being counted towards currently available capacity;
applying a multiplier to a location in which available resources are overcommitted to reduce a likelihood of further resources being committed;
applying a cost efficiency weighting to available capacity based on machine type; or
avoiding a single virtual machine (VM) from being split across multiple machines.

5. The method of claim 4, wherein the supply signaling further indicates a supply lead time for new computing resource inventory to become available in the cloud computing environment, wherein a record of available computing resource inventory includes recording the lead time, and wherein the demand signaling is associated with a demand lead time indicative of when new demand will be received.

6. The method of claim 1, wherein the common SDM logic is configured to match supply signaling to demand signaling based at least in part on the supply lead time and the demand lead time.

7. The method of claim 6, wherein the common SDM logic is configured to match imminent demand with currently available computing resources, and to match forecasted demand with future available computing resources.

8. The method of claim 5, wherein each of the supply lead time and the demand lead time is selected from a plurality of lead time categories, wherein the lead time categories include at least:
an imminent lead time indicating immediately available computing resources and immediate computing resource demand, respectively;
a reserved lead time indicating incoming computing resources that will be available on the order of days and forecasted computing resource demand that will be received on the order of days, respectively; and
an in-transit lead time indicating incoming computing resources that will be available on the order of weeks and forecasted computing resource demand that will be received on the order of weeks, respectively.

9. The method of claim 8, wherein, for supply signaling indicating the in-transit lead time, the supply signaling further indicates a vendor of the incoming computing resources, and wherein an amount of the incoming computing resources that will be available on the order of weeks is approximated based at least in part on historical fulfillment data of the vendor.

10. The method of claim 1, wherein the supply signaling indicates a VM type, and wherein the common SDM logic is configured to match supply signaling to demand signaling based at least in part on mappings between VM types and compatible machine types.

11. A system comprising:
memory storing a supply-demand matching (SDM) logic framework for matching resources of a cloud computing environment with requests for the resources of the cloud computing environment, wherein each of the resources and requests includes an indication of lead time; and
one or more processors of a global cloud inventory availability system configured to:
access the SDM logic framework;
match the resources with the requests in accordance with the SDM logic framework based at least in part on the lead time;
receive, from a plurality of capacity management subsystems, a plurality of respective capacity planning signals, wherein each capacity management subsystem is assigned to perform a different capacity management action type; and
for each capacity planning signal, transmit an indication of the matched resources and requests relevant to the capacity planning signal to the capacity management subsystem from which the capacity planning signal was sent.

12. The system of claim 11, wherein the plurality of action types are selected from the group consisting of: reserving computing resource inventory for a forecasted demand; determining pool sizes for domains of the cloud computing environment; moving computing resource inventory between domains of the cloud computing environment; moving projects between domains of the cloud computing environment; and moving demand for computing resource inventory between domains of the cloud computing environment.

13. The system of claim 11, wherein the one or more processors are configured to match the resources with the requests based further on at least one of computation capacity, storage capacity or virtual machine (VM) type.

14. The system of claim 11, wherein the SDM logic framework includes at least one of:
a bin packing rule for reducing fragmentation of stored data;
a VM integrity rule for ensuring that VMs are not scheduled across multiple machines of the resources of the cloud computing environment;
a place in line rule for addressing requests on a first-come first-served basis;
a holdback rule for ensuring that held-back resources are not counted towards available capacity of the cloud computing environment; or
a clustering rule for moving requests between cells of a common cluster of the cloud computing environment.

15. The system of claim 14, wherein the SDM logic framework includes at least three of the bin packing rule, the VM integrity rule, the place in rule, the holdback rule, and the clustering rule.

16. The system of claim 11, wherein lead time for the resources indicates a time that the resources become available in the cloud computing environment, and wherein lead time for the requests indicates when projects included in the requests will be executed.

17. The system of claim 16, wherein the one or more processors are configured to:
match resources having an imminent lead time with requests having the imminent lead time;
match resources having a ready-for-reservation lead time with requests having the ready-for-reservation lead time; and
transmit an indication of the matched resources and requests having the imminent and ready-for-reservation lead times to one or more capacity management subsystems configured to perform one of short-term supply shaping or short-term demand steering.

18. The system of claim 16, wherein the one or more processors are configured to:
match resources having an in-transit lead time with requests having the in-transit lead time;
transmit an indication of said matched resources and requests having the in-transit lead time to one or more capacity management subsystems configured to perform one of long-term supply shaping or long-term demand forecasting.

19. The system of claim 18, wherein the one or more processors are configured to determine a level of confidence of delivery of the resources having the in-transit lead time based on a vendor delivering the resources having the in-transit lead time, and historical fulfillment data of the vendor.

20. The system of claim 11, wherein the memory includes a mapping between a plurality of VM types and a plurality of machine platforms, and wherein the one or more processors are configured to match the resources with the requests in accordance with the SDM logic framework based further on the mapping.
